(19) United States
(12) Patent Application Publication
(10) Pub. No.: US 2013/0048894 A1
(43) Pub. Date: Feb. 28, 2013

(54) CONTINUOUS TURN BI-DIRECTIONAL AIR VENT ACTUATOR

(71) Applicant: Dennis Horejsi, Agassiz (CA)

(72) Inventor: Dennis Horejsi, Agassiz (CA)

(73) Assignee: PETRA DETENTION GROUP INC., Evansburg (CA)

(21) Appl. No.: 13/590,543

(22) Filed: Aug. 21, 2012

(30) Foreign Application Priority Data
Aug. 26, 2011 (CA) 2751093

(51) Int. Cl. F16K 31/44

(52) U.S. Cl. 251/279

(57) ABSTRACT

A continuous turn, bi-directional, air vent actuator for an air vent, the air vent having a body with a vent opening and a vent closure movable between a closed position blocking flow of air through the vent opening and an open position allowing flow of air through the vent opening. The air vent actuator having a linkage extending between the linkage attachment end of the neck that rotates with the handle and the vent closure. The linkage includes a first link that has an off-centre arm with an extremity that orbits the neck. A second link pivots relative to the vent closure about a first pivot axis to accommodate the orbital position of the off-centre arm. The second link has a socket in which the extremity of the off-centre arm twisting in the socket as the orbital position changes.

### FIELD

There is described a continuous turn, bi-directional, actuator for use in opening and closing an air vent.

### BACKGROUND

Facilities where inmates, such as criminals or mental patients, are incarcerated have tamper proof air vents. These air vents require an actuator, usually in the form of a knob, to selectively open and close the air vent. Problems are presently being experienced with inmates deliberately breaking off the knob, by twisting it past its rotational stop point. What is required is an air vent actuator that cannot be damaged by intentional over rotation.

### SUMMARY

There is provided a continuous turn, bi-directional, air vent actuator for use with an air vent. In particular, the air vent actuator is designed to work with a Kawneer 512 Ventro air vent, however it will be understood that the air vent actuator can be used with other air vents of the same general construction. The Kawneer 512 ventro air vent is a commercial made vent and is designed to be operated by hand. In order to use the 512 ventro in a secure facility, there must be a protective guard installed in front of the vent. With a protective guard in place the vent cannot be opened by hand. The air vent actuator must be used to open and close the vent. The vent has a body with a vent opening and a vent closure movable between a closed position blocking flow of air through the vent opening and an open position allowing flow of air through the vent opening. A perforated protective guard overlies the vent opening. The protective guard has an exterior surface, an interior surface defining a linkage cavity, and a neck receiving opening extending from the exterior surface to the interior surface. A neck extends through the neck receiving opening. The neck has a handle end extending beyond the exterior surface of the protective guard and a linkage attachment end extending beyond the interior surface into the linkage cavity. A handle is secured to the handle attachment end of the neck. Rotational input in either of a clockwise or counter-clockwise direction results in concentric rotation of the neck. A linkage extends between the linkage attachment end of the neck to the vent closure. The linkage includes a first link that rotates with the neck. The first link has an off-centre arm that orbits the neck. The off-centre arm has an extremity. A second link is attached to the vent closure. The second link pivots relative to the vent closure about a first pivot axis to accommodate the orbital position of the off-centre arm as the neck rotates. The second link has a socket in which the extremity is received, the extremity rotating in the socket as with the orbital positioning of the off-centre arm. The first link applies a force upon the second link to move the vent closure between the open position and the closed position as the off-centre arm orbits the neck with the extremity of the off-centre arm twisting in the socket as the orbital position changes.

The vent actuator, as described above, has no stop position. The knob can be rotated continuously in either a clockwise or a counter-clockwise direction. The linkage accommodates moves the vent closure toward the open position or the closed position depending upon the rotational position of the neck.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a continuous turn, bi-directional, air vent actuator, with the vent closed.

FIG. 2 is a perspective view of the continuous turn, bi-directional, air vent actuator illustrated in FIG. 1 with the vent partially open.

FIG. 3 is a perspective view of the continuous turn, bi-directional, air vent actuator illustrated in FIG. 1 with the vent fully open.

FIG. 4 is a side elevation view, in section, of the continuous turn, bi-directional, air vent actuator, with the vent open.

FIG. 5 is a side elevation view, in section, continuous turn, bi-directional, air vent actuator illustrated in FIG. 1 with the vent closed.

FIG. 6 is a side elevation view, in section, of the continuous turn, bi-directional, air vent actuator illustrated in FIG. 1 with the vent partially open.

FIG. 7 is a side elevation view, in section, of the continuous turn, bi-directional, air vent actuator illustrated in FIG. 1 with the vent open.

FIG. 8 is an exploded view of the handle of the continuous turn, bi-directional, air vent actuator illustrated in FIG. 1.

### DETAILED DESCRIPTION

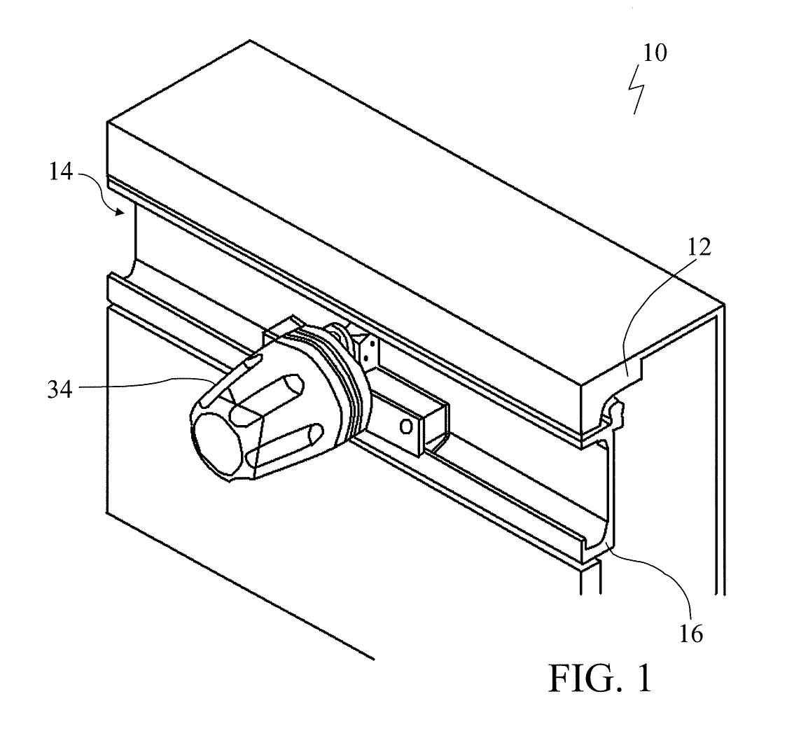

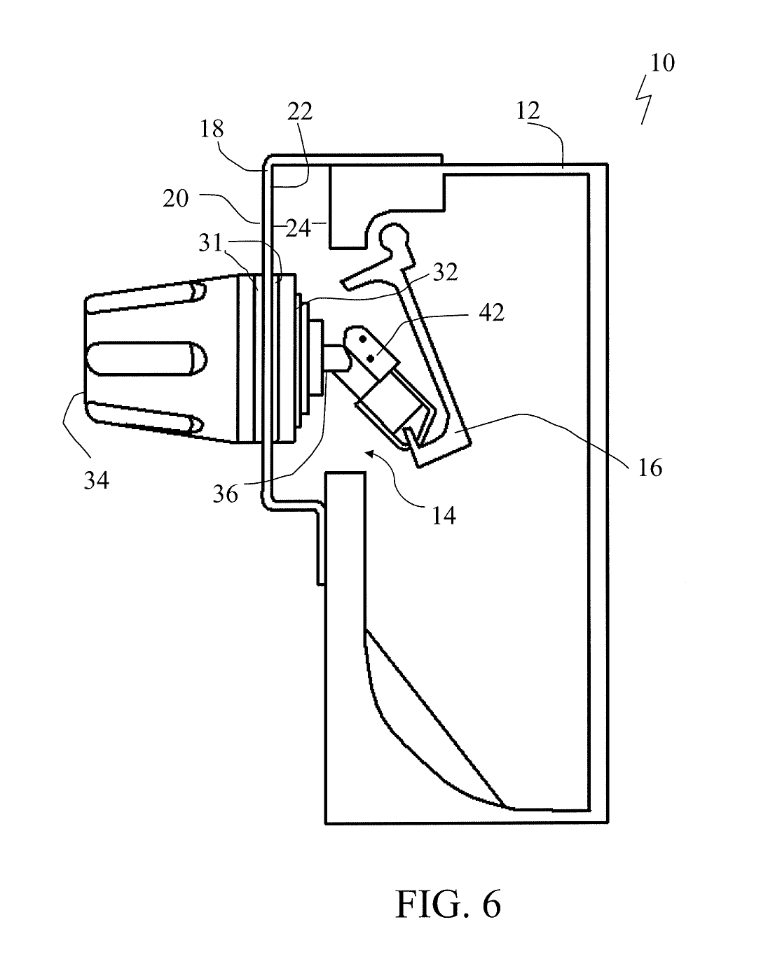

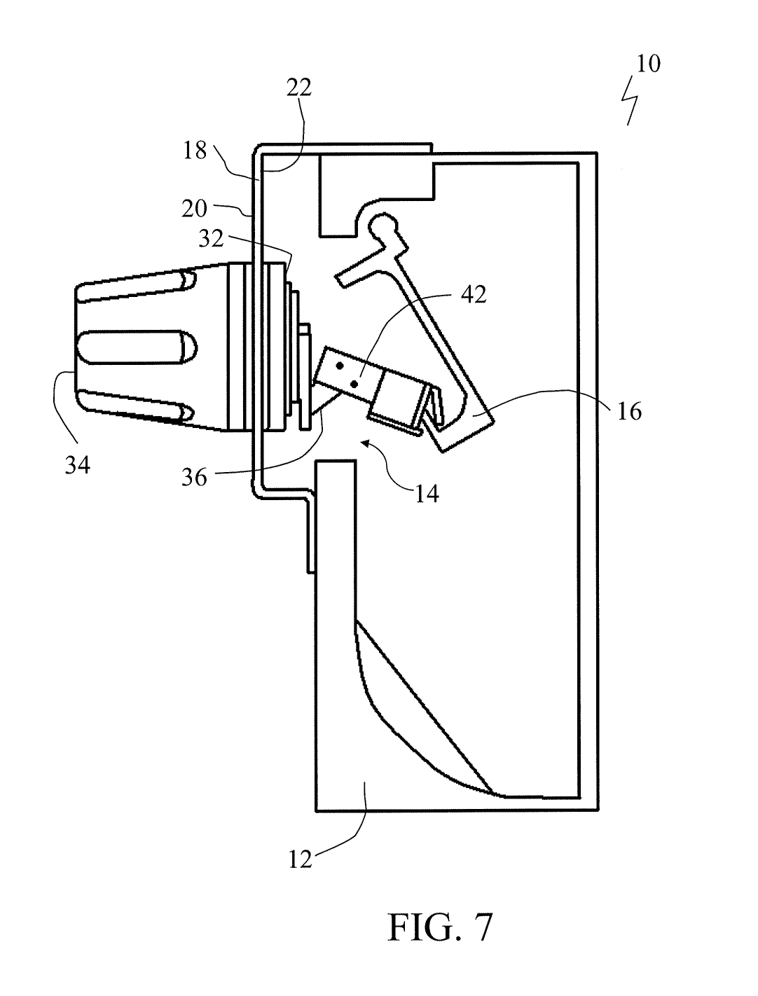

A continuous turn, bi-directional, air vent actuator generally identified by reference numeral 10, will now be described with reference to FIG. 1 through 8.

### Structure and Relationship of Parts:

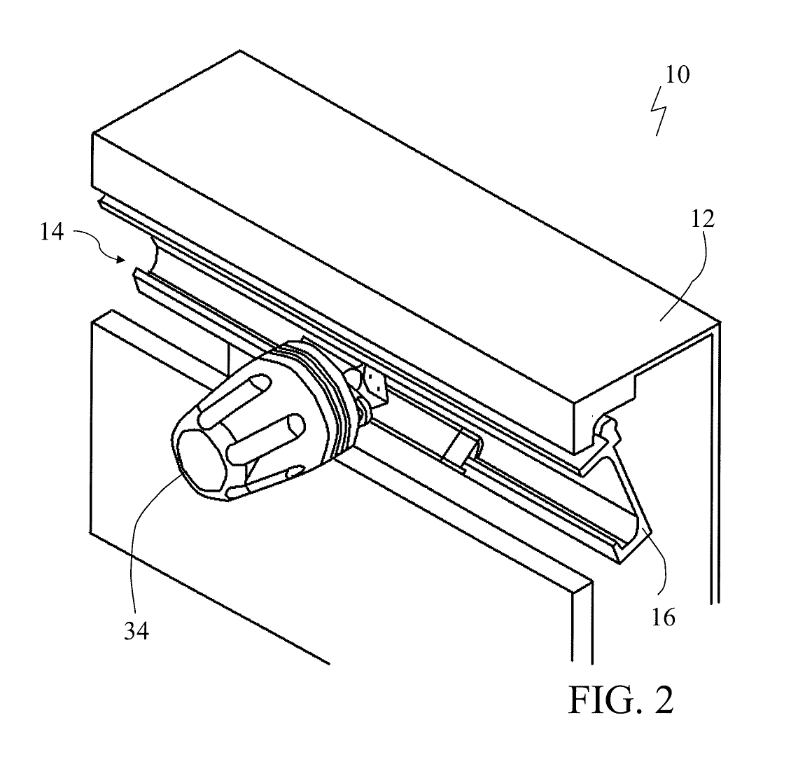

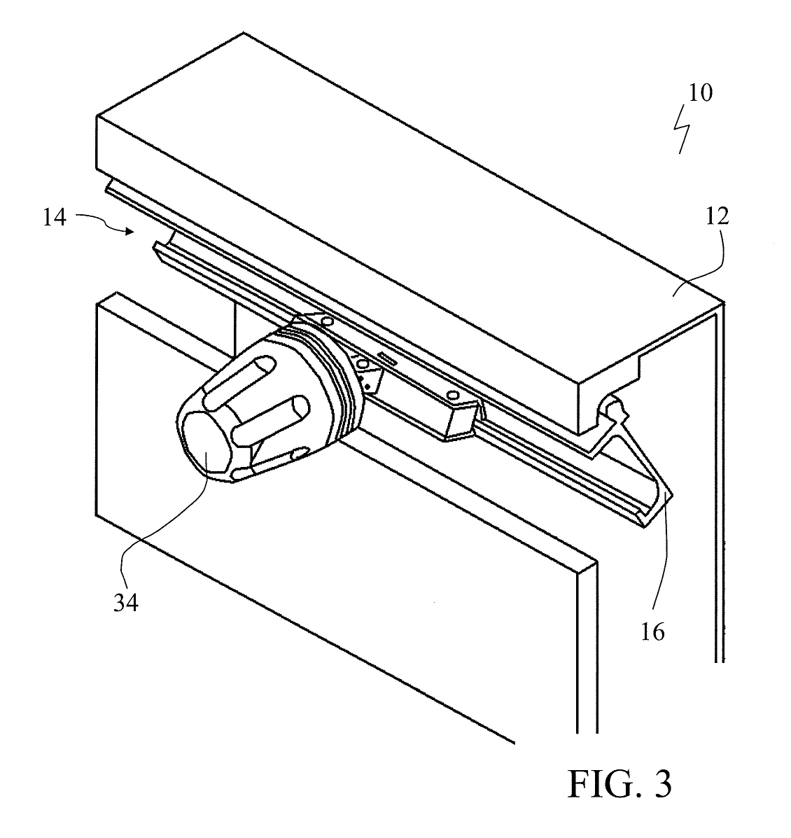

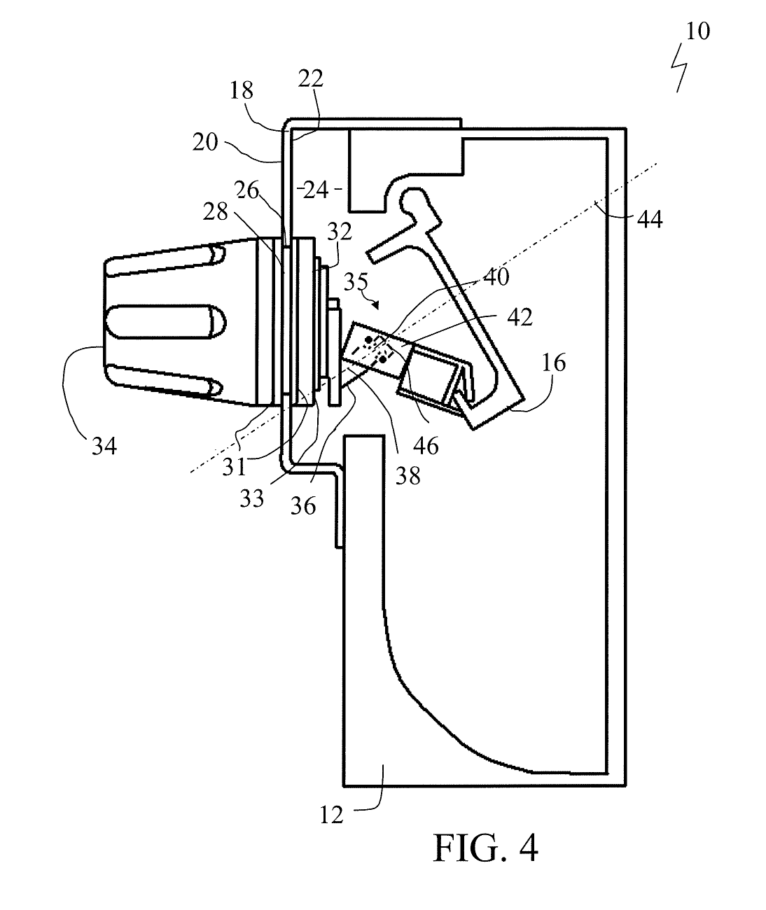

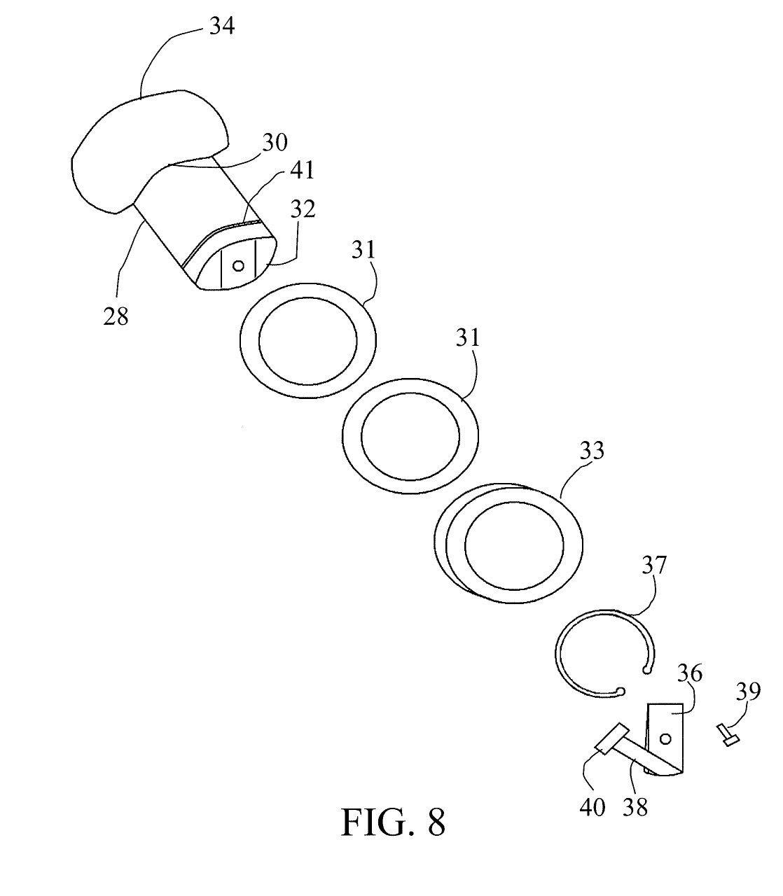

Referring to FIG. 1, there is illustrated a continuous turn, bi-directional, air vent actuator 10. Air vent actuator 10 has a body 12 with a vent opening 14. A vent closure 16 is provided that is movable between a closed position illustrated in FIG. 1 blocking flow of air through vent opening 14 and an open position illustrated in FIG. 2 and FIG. 3 allowing flow of air through vent opening 14. Referring to FIG. 4 through FIG. 7, a perforated protective guard 18 overlies vent opening 14. Protective guard 18 has an exterior surface 20 and an interior surface 22 which defines a linkage cavity 24. Protective guard 18 also has a neck receiving opening 26 which extends from exterior surface 20 to interior surface 22. Referring to FIG. 4, a neck 28 extends through neck receiving opening 26. Neck 28 has a handle end 30, shown in FIG. 8, that extends beyond exterior surface 20 of protective guard 18 and a linkage attachment end 32 that extends beyond interior surface 22 into linkage cavity 24.

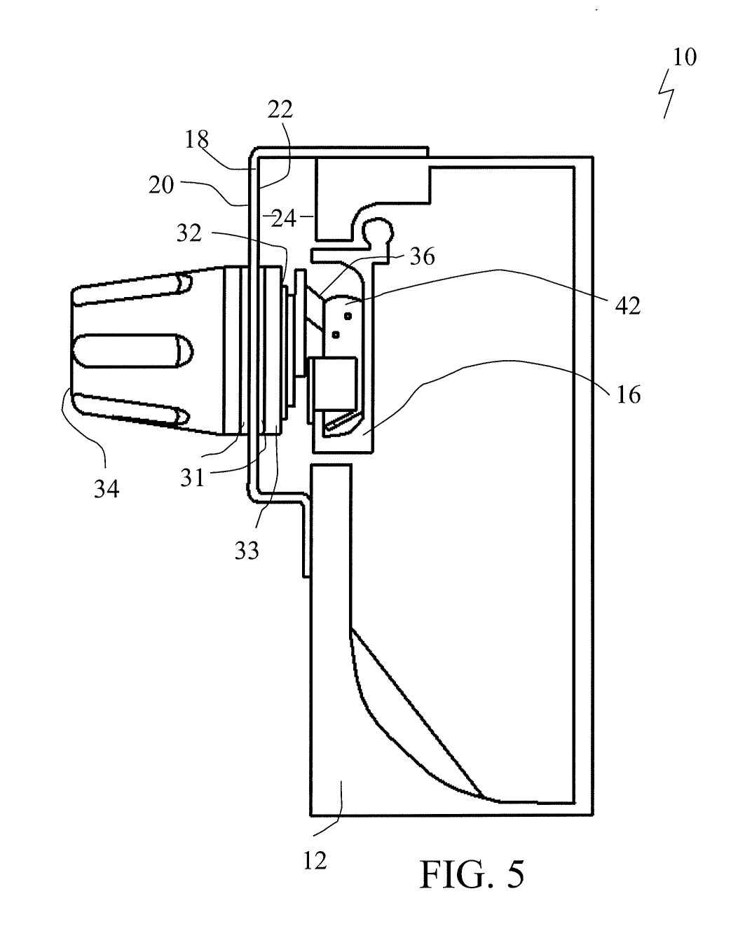

Referring to FIG. 8, a handle 34 is secured to handle end 30 of neck 28. Rotational input in either of a clockwise or counterclockwise direction results in concentric rotation of neck 28. Two plastic guards 31 slide onto neck 28 and are held in position on neck 28 between handle 34 and a bearing plate 33. Bearing plate 33 is positioned at linkage attachment end 32 of neck 28. A snap ring 37 is positioned within groove 41 on neck 28 to prevent removal of plastic guards 31 and bearing plate 33 from linkage attachment end 32 of neck 28. A screw 39 connects first link 36 to neck 28 of handle 34. Referring to FIG. 5, plastic guards 31 are positioned on either side of perforated protective guard 18 when handle 34 is installed.

Referring to FIG. 4, a linkage, generally indicated by reference numeral 35, extends between linkage attachment end 32 of neck 28 to vent closure 16. Linkage 35 includes a first link 36 that rotates with neck 28. First link 36 has an off-centre arm 38 that orbits neck 28. Off-centre arm 38 has an extremity 40. A second link 42 is attached to vent closure 16. Second link 42 pivots relative to vent closure 16 about a first pivot axis identified by broken lines 44 to accommodate the orbital position of off-centre arm 38 as neck 28 rotates. Second link 42 has a socket 46, in which extremity 40 is received. First link 36 applies a force upon second link 42 to move vent closure 16 between the open position illustrated in FIG. 3, and the closed position illustrated in FIG. 1, as off-centre arm 38 orbits neck 28 with extremity 40 of off-centre arm 38 twisting in socket 46 as orbital position changes.

### Operation:

Referring FIG. 1, air vent actuator 10 can be installed in facilities where tamper proof air vents are required. Referring to FIG. 4 through FIG. 7, air vent actuator 10 is installed with protective guard 18 protecting vent opening 14. Air vent actuator 10 solves the problem of inmates deliberately breaking off the knob, by twisting it past its rotational stop point. Linkage 35 accommodates continuous turning. All that an inmate will accomplish is the repeated opening and closing of the vent. Referring to FIG. 4 through FIG. 7, when the inmate turns handle 34, off-centre arm 38 of first link 36 orbits neck 28 that supports handle 34. Second link 42 pivots relative to vent closure 16 about first pivot axis 44 and extremity 40 of off-centre arm 38 twists in socket 46 as the orbital position changes of off-centre arm 38 changes. As can be seen from a review of FIG. 4 through FIG. 7, continuous turning merely results in continuous movement of vent closure 16.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A continuous turn, bi-directional, air vent actuator for a vent, the vent comprising a body having a vent opening, a vent closure movable between a closed position blocking flow of air through the vent opening and an open position allowing flow of air through the vent opening and a perforated protective guard overlying the vent opening, the protective guard having an exterior surface, an interior surface defining a linkage cavity, and a neck receiving opening extending from the exterior surface to the interior surface, the air vent actuator comprising:
a neck extending through the neck receiving opening, the neck having a handle end extending beyond the exterior surface of the protective guard and a linkage attachment end extending beyond the interior surface into the linkage cavity;
a handle secured to the handle attachment end of the neck, rotational input in either of a clockwise or counterclockwise direction resulting in concentric rotation of the neck;
a linkage extending between the linkage attachment end of the neck to the vent closure, the linkage comprising:
a first link that rotates with the neck, the first link having an off-centre arm that orbits the neck, the off-centre arm having an extremity;
a second link that is attached to the vent closure, the second link pivoting relative to the vent closure about a first pivot axis to accommodate the orbital position of the off-centre arm as the neck rotates, the second link having a socket in which the extremity is received, the first link applying a force upon the second link to move the vent closure between the open position and the closed position as the off-centre arm orbits the neck with the extremity of the off-centre arm twisting in the socket as the orbital position changes.
